(19) United States
(12) Patent Application Publication
(10) Pub. No.: US 2024/0355333 A1
(43) Pub. Date: Oct. 24, 2024

(54) INFORMATION PROCESSING SYSTEM, INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Yoshinori Koda, Tokyo (JP)

(73) Assignee: NEC Corporation, Minato-ku, Tokyo (JP)

(21) Appl. No.: 18/292,475

(22) PCT Filed: Aug. 6, 2021
(86) PCT No.: PCT/JP2021/029412

§ 371 Date: Jan. 26, 2024

(51) Int. Cl. G10L 17/06

(52) U.S. Cl. CPC G10L 17/06

(57) ABSTRACT

An information processing system includes: an acquisition unit that obtains conversation data including speech information on a plurality of people; a keyword extraction unit that extracts a keyword from the speech information; a feature quantity extraction unit that extracts a first feature quantity that is a feature quantity related to a voice when the keyword is said, from the speech information; and a generation unit that generates information for collation/verification, by associating the keyword with the first feature quantity. According to such an information processing system, it is possible to properly generate the information for collation/verification, from the conversation data.

### TECHNICAL FIELD

This disclosure relates to technical fields of an information processing system, an information processing apparatus, an information processing method, and a recording medium.

### BACKGROUND ART

A known system of this type utilizes a keyword for speech recognition techniques/technologies. For example, Patent Literature 1 discloses a technology/technique of detecting a keyword sound, which is a sound when a predetermined keyword is said, from an inputted speech. Patent Literature 2 discloses a technology/technique of creating a keyword list and extracting an important word from speech information. Patent Literature 3 discloses a technology/technique of extracting a keyword to be used to identify a user's interest from the content of an input that is recognized by speech recognition. Patent Literature 4 discloses a technology/technique of generating a keyword from character information generated by the speech recognition.

As another related t technique/technology, Patent Literature 5 discloses a technology/technique of generating a voice print of a user, on the basis of information about a vocal tract of the user and behavior of patterns of a way of talking of the user.

### CITATION LIST

### Patent Literature

Patent Literature 1: JP2020-086011A
Patent Literature 2: JP2015-099290A
Patent Literature 3: JP2009-294790A
Patent Literature 4: JP2007-257134A
Patent Literature 5: JP2014-517366A

### SUMMARY

### Technical Problem

This disclosure aims to improve the techniques/technologies disclosed in Citation List.

### Solution to Problem

An information processing system according to an example aspect of this disclosure includes: an acquisition unit that obtains conversation data including speech information on a plurality of people; a keyword extraction unit that extracts a keyword from the speech information; a feature quantity extraction unit that extracts a first feature quantity that is a feature quantity related to a voice when the keyword is said, from the speech information; and a generation unit that generates information for collation/verification, by associating the keyword with the first feature quantity.

An information processing apparatus according to an example aspect of this disclosure includes: an acquisition unit that obtains conversation data including speech information on a plurality of people; a keyword extraction unit that extracts a keyword from the speech information; a feature quantity extraction unit that extracts a first feature quantity that is a feature quantity related to a voice when the keyword is said, from the speech information; and a generation unit that generates information for collation/verification, by associating the keyword with the first feature quantity.

An information processing method according to an example aspect of this disclosure includes: obtaining conversation data including speech information on a plurality of people; extracting a keyword from the speech information; extracting a first feature quantity that is a feature quantity related to a voice when the keyword is said, from the speech information; and generating information for collation/verification, by associating the keyword with the first feature quantity.

A recording medium according to an example aspect of this disclosure is a recording medium on which a computer program that allows at least one computer to execute an information processing method is recorded, the information processing method including: obtaining conversation data including speech information on a plurality of people; extracting a keyword from the speech information; extracting a first feature quantity that is a feature quantity related to a voice when the keyword is said, from the speech information; and generating information for collation/verification, by associating the keyword with the first feature quantity.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of an information generation operation by the information processing system according to the first example embodiment.

FIG. 4 is a block diagram illustrating a functional configuration of an information processing system according to a second example embodiment.

FIG. 5 is a flowchart illustrating a flow of an information generation operation by the information processing system according to the second example embodiment.

FIG. 6 is a conceptual diagram illustrating a specific example of speaker classification by an information processing system according to a third example embodiment.

FIG. 7 is a conceptual diagram illustrating a specific example of speaker integration by the information processing system according to the third example embodiment.

FIG. 8 is a conceptual diagram illustrating a specific example of keyword extraction by the information processing system according to the third example embodiment.

FIG. 9 is a table illustrating an example of a storage aspect of a keyword in the information processing system according to the third example embodiment.

FIG. 10 is a block diagram illustrating a functional configuration of an information processing system according to a fourth example embodiment.

FIG. 11 is a flowchart illustrating a flow of a permission determination operation by the information processing system according to the fourth example embodiment.

FIG. 12 is a plan view illustrating an example of presentation by the information processing system according to the fourth example embodiment.

FIG. 13 is a plan view illustrating an example of display of a file handled by the information processing system according to the fourth example embodiment.

FIG. 14 is a block diagram illustrating a functional configuration of an information processing system according to a fifth example embodiment.

FIG. 15 is a flowchart illustrating a flow of a permission determination operation by the information processing system according to the fifth example embodiment.

FIG. 16 is a plan view illustrating an example of a keyword display change by the information processing system according to the fifth example embodiment.

FIG. 17 is version 1 of a block diagram illustrating an application example of an information processing system according to a sixth example embodiment.

FIG. 18 is version 2 of a block diagram illustrating an application example of the information processing system according to the sixth example embodiment.

FIG. 19 is version 3 of a block diagram illustrating an application example of the information processing system according to the sixth example embodiment.

FIG. 20 is a plan view illustrating an example of display by an information processing system 10 according to a seventh example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

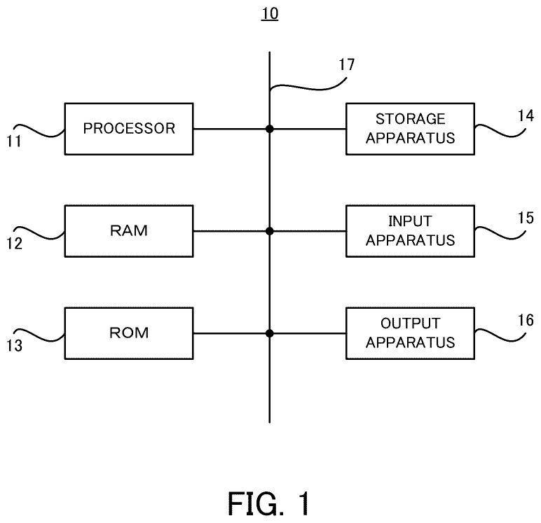

An information processing system according to a first example embodiment will be described with reference to FIG. 1 to FIG. 3.

### (Hardware Configuration)

First, a hardware configuration of the information processing system according to the first example embodiment will be described with reference to FIG. 1. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing system 10, through a network interface. The processor 11 controls he RAM 12, the storage apparatus 14, the input apparatus 15, and the output apparatus 16 by executing the read computer program. Especially in this example embodiment, when the processor 11 executes the read computer program, a functional block for extracting a keyword from conversation data and generating information is realized or implemented in the processor 11.

The processor 11 may be configured as, for example, a CPU (Central Processing Unit), a GPU (Graphics Processing Unit), a FPGA (field-programmable gate array), a DSP (Demand-Side Platform) or an ASIC (Application Specific Integrated Circuit). The processor 11 may be one of them, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that are stored for a long term by the information processing system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone or a tablet.

The output apparatus 16 is an apparatus that outputs information about the information processing system 10 to the outside. For example, the output apparatus 16 may be a display apparatus (e.g., a display) that is configured to display the information about the information-processing system 10. The output apparatus 16 may be a speaker or the like that is configured to audio-output the information about the information processing system 10. The output apparatus 16 may be configured as a portable terminal such as a smartphone or a tablet.

Although FIG. 1 illustrates the information processing system 10 including a plurality of apparatuses, all or a part of the functions thereof may be realized in a single apparatus (information processing apparatus). The information processing apparatus may include only the processor 11, the RAM12, and the ROM13, for example, and an external apparatus connected to the information processing apparatus may include other components (i.e., the storage apparatus 14, the input apparatus 15, and the output apparatus 16), for example. In the information processing apparatus, a part of an arithmetic function may also be realized by an external apparatus (e.g., an external server or cloud).

### (Functional Configuration)

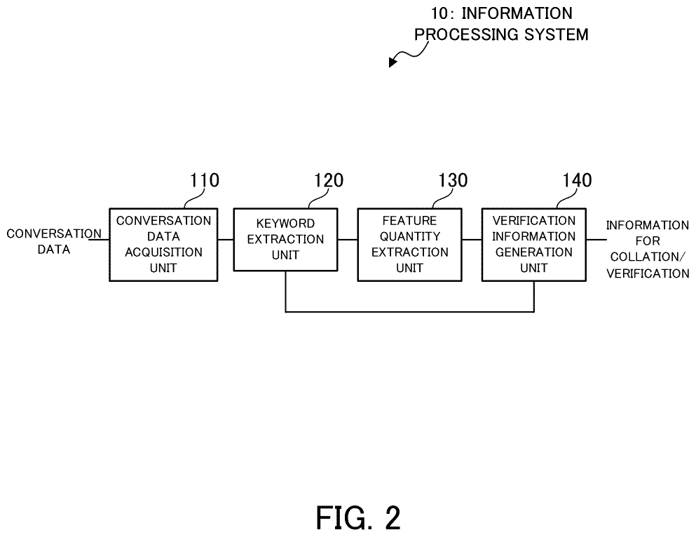

Next, a functional configuration of the information processing system 10 according to the first example embodiment will be described with reference to FIG. 2. FIG. 2 is a block diagram illustrating the functional configuration of the information processing system according to the first example embodiment.

As illustrated in FIG. 2, the information processing system 10 according to the first example embodiment includes, as components for realizing the functions thereof, a conversation data acquisition unit 110, a keyword extraction unit 120, a feature quantity extraction unit 130, and a verification information generation unit 140. Each of the conversation data acquisition unit 110, the keyword extraction unit 120, the feature quantity extraction unit 130, and the verification information generation unit 140 may be a processing block realized or implemented by the processor 11 (see FIG. 1), for example.

The conversation data acquisition unit 110 obtains conversation data including speech information on a plurality of people. The conversation data acquisition unit 110 may directly obtain the conversation data from a microphone or the like, or may obtain the conversation data generated by another apparatus or the like, for example. An example of the conversation data includes meeting data obtained by recording a speech/voice at a meeting/conference, or the like. The conversation data acquisition unit 110 may be configured to perform various processes on the obtained conversation data. For example, the conversation data acquisition unit 110 may be configured to perform a process of detecting a speaker speaking section of the conversation data, a process of performing speech recognition and converting the conversation data into text, and a process of classifying the speaker who is speaking.

The keyword extraction unit 120 extracts a keyword included in the content of an utterance/speaking, from the speech information in the conversation data obtained by the conversation data acquisition unit 110. The keyword extraction unit 120 may extract the keyword randomly from words included in the speech information, or may extract a predetermined word as the keyword. The keyword extraction unit 120 may determine the keyword to be extracted in accordance with the content of the conversation data. For example, the keyword extraction unit 120 may extract a word of high frequency of appearance in the conversation data (e.g., a word that is said a predetermined number of times or more) as the keyword. The keyword extraction unit 120 may extract a plurality of keywords from one piece of conversation data. The keyword extraction unit 120 may extract at least one keyword for each of the plurality of people.

The feature quantity extraction unit 130 is configured to extract a feature quantity related to a voice when the keyword extracted in the keyword extraction unit 120 is said (hereinafter referred to as a “first feature quantity” as appropriate). When a plurality of keywords are extracted in the keyword extraction unit 120, the feature quantity extraction unit 130 may extract feature quantities for all the keywords, or may extract feature quantities only for a part of the keywords. A detailed description of a method of extracting the feature quantity related to the voice will be omitted here, because the existing techniques/technologies may be adopted to the method as appropriate.

The verification information generation unit 140 is configured to generate information for collation/verification, by associating the keyword extracted by the keyword extraction unit 120 with the first feature quantity extracted by the feature quantity extraction unit 130. For example, the verification information generation unit 140 may associate a first keyword with a feature quantity related to a voice when the first keyword is said, and may associate a second keyword with a feature quantity related to a voice when the second keyword is said. The information for collation/verification generated by the verification information generation unit 140 is used for voice collation/verification of a plurality of people who participate in a conversation. A specific method of using the information for collation/verification will be described in detail in another example embodiment later.

### (Information Generation Operation)

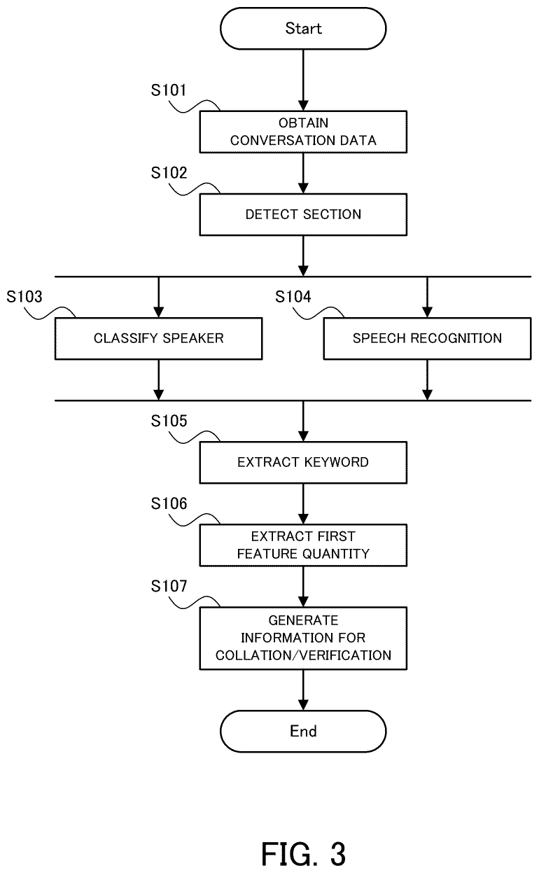

Next, a flow of an operation when the information for collation/verification is generated by the information processing system 10 according to the first example embodiment (hereinafter referred to as an “information generation operation” as appropriate) will be described with reference to FIG. 3. FIG. 3 is a flowchart illustrating the flow of an information generation operation performed by the information processing system according to the first example embodiment.

As illustrated in FIG. 3, in the information generation operation by the information processing system 10 according to the first example embodiment, first, the conversation data acquisition unit 110 obtains the conversation data including the speech information on a plurality of people (step S101). Then, the conversation data acquisition unit 110 performs the process of detecting the speaker speaking section of the conversation data (hereinafter referred to as a “section detection process”) (step S102). The section detection process may be, for example, a process of detecting and trimming a silent section.

Subsequently, the conversation data acquisition unit 110 performs a process of classifying a speaker (hereinafter referred to as a “speaker classification process”), from the conversation data on which the section detection process is performed (i.e., the speech information in the speaking section) (step S103). The speaker classification process may be, for example, a process of adding a label corresponding to a speaker to each section of the conversation data.

On the other hand, the conversation data acquisition unit 110 performs a process of performing the speech recognition and converting into text the conversation data on which the section detection process is performed (hereinafter referred to as a “speech recognition process” as appropriate) (step S104). A detailed description of a specific method of the speech recognition process will be omitted here, because the existing techniques/technologies may be adopted to the method as appropriate. The speech recognition process and the above-described speaker classification process may be simultaneously performed in parallel, or may be sequentially performed one after the other.

Subsequently, the keyword extraction unit 120 extracts the keyword from the conversation data on which the speech recognition process is performed (i.e., text data) (step S105). At this time, the keyword extraction unit 120 may extract the keyword by using a result of the speaker classification process (e.g., by distinguishing speakers). The keyword extraction unit 120 may extract a word of the same Japanese Kanji but having different readings, by distinguishing the readings. For example, in the case of a Japanese Kanji meaning “one”, it may be extracted separately for a reading of “ichi” and a reading of “hitotsu”.

Subsequently, the feature quantity extraction unit 130 extracts the feature quantity related to the voice when the keyword extracted by the keyword extraction unit 120 is said (i.e., the first feature quantity) (step S106). Then, the verification information generation unit 140 generates the information for collation/verification by associating the keyword extracted by the keyword extraction unit 120 with the first feature quantity extracted by the feature quantity extraction unit 130 (step S107).

### Technical Effect

Next, a technical effect obtained by the information processing system 10 according to the first example embodiment will be described.

As described in FIG. 1 to FIG. 3, in the information processing system 10 according to the first example embodiment, the information for collation/verification is generated by associating the keyword extracted from the conversation data with the feature quantity related to the voice (i.e., the first feature quantity). In this way, it is possible to properly generate the information for collation/verification from the conversation data including the speech information on a plurality of people. Therefore, it is possible to properly perform a voice collation/verification process using the keyword, on a plurality of people who participate in a conversation. Furthermore, in this example embodiment, since the keyword is extracted from the conversation data, there is no need to separately prepare a keyword to be used in the speech collation/verification process. Therefore, it is possible to reduce labor/time required to generate the information for collation/verification.

When a keyword of a predetermined voice/sound is shared or reused, this sharing or reuse may be handled by a maliciously recorded voice or voice synthesis. In this example embodiment, however, a predetermined keyword is not used (the keyword can be generated from the conversation data), and it is thus possible to increase security/robustness to a malicious action. Furthermore, since the keyword is automatically generated from the conversation data, advanced registration is not required, and there is no need to have a user consciously prepare the keyword. In addition, it is possible to avoid forgetting the keyword. For example, if different keywords are prepared at a plurality of meetings, accuracy may be increased, but the possibility of forgetting the keyword is also increased. In this example embodiment, however, it is also possible to avoid a situation in which the keyword is forgotten, while realizing the same accuracy as in the case of preparing a plurality of keywords.

### Second Example Embodiment

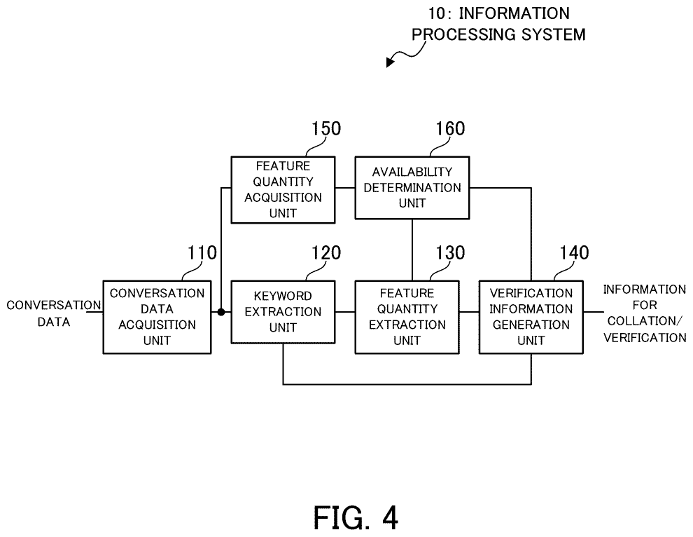

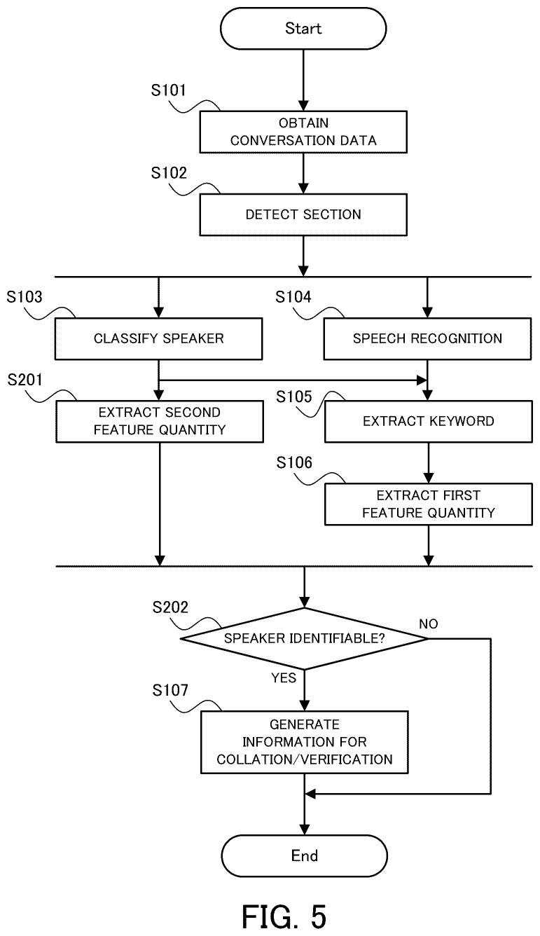

The information processing system 10 according to a second example embodiment will be described with reference to FIG. 4 and FIG. 5. The second example embodiment is partially different from the first example embodiment only in the configuration and operation, and may be the same as the first example embodiment in the other parts. For this reason, a part that is different from the first example embodiment described above will be described in detail below, and a description of other overlapping parts will be omitted as appropriate.

### (Functional Configuration)

First, a functional configuration of the information processing system 10 according to the second example embodiment will be described with reference to FIG. 4. FIG. 4 is a block diagram illustrating the functional configuration of the information processing system according to the second example embodiment. In FIG. 4, the same components as those illustrated in FIG. 2 carry the same reference numerals.

As illustrated in FIG. 4, the information processing system 10 according to the second example embodiment includes, as components for realizing the functions thereof, the conversation data acquisition unit 110, the keyword extraction unit 120, the feature quantity extraction unit 130, the verification information generation unit 140, a feature quantity acquisition unit 150, and an availability determination unit 160. That is, the information processing system 10 according to the second example embodiment further includes the feature quantity acquisition unit 150 and the availability determination unit 160 in addition to the configuration in the first example embodiment (see FIG. 2). Each of the feature quantity acquisition unit 150 and the availability determination unit 160 may be, for example, a processing block realized or implemented by the processor 11 (see FIG. 1).

The feature quantity acquisition unit 150 is configured to obtain a feature quantity related to a voice of at least one of a plurality of people who participate in a conversation (hereinafter referred to as a “second feature quantity” as appropriate). The feature quantity acquisition unit 150 may obtain the second feature quantity from the conversation data obtained by the conversation data acquisition unit 110. For example, the feature quantity acquisition unit 150 may extract the second feature quantity from the conversation data on which the speaker classification process is performed. Alternatively, the feature quantity acquisition unit 150 may obtain the second feature quantity that is prepared in advance. For example, it may obtain the second feature quantity stored in association with a personal ID and a terminal carried by each of the plurality of people who participate in a conversation.

The availability determination unit 160 is configured to compare the first feature quantity extracted by the feature quantity extraction unit 130 with the second feature quantity obtained by the feature quantity acquisition unit 150, and to determine whether or not the speaker who says the keyword is identifiable from the first feature quantity. That is, the availability determination unit 160 is configured to determine whether or not the first feature quantity corresponding to the keyword is available for the voice collation/verification. The availability determination unit 160 collates/verifies the first feature quantity and the second feature quantity extracted from the same speaker, and when it can be determined that those speakers are the same person, the first feature quantity may be determined to be available for the voice collation/verification. Furthermore, the availability determination unit 160 may collate/verify the first feature quantity and the second feature quantity extracted from the same speaker, and when it is determined that those speakers are not the same person, the first feature quantity may be determined to be not available for the voice collation/verification.

### (Information Generation Operation)

Next, a flow of an information generation operation by the information processing system 10 according to the second example embodiment will be described with reference to FIG. 5. FIG. 5 is a flowchart illustrating the flow of the information generation operation performed by the information processing system according to the second example embodiment. In FIG. 5, the same steps as those described in FIG. 3 carry the same reference numerals.

As illustrated in FIG. 5, in the information generation operation performed by the information processing system 10 according to the second example embodiment, first, the conversation data acquisition unit 110 obtains the conversation data including the speech information on a plurality of people (step S101). Then, the conversation data acquisition unit 110 performs the section detection process (step S102).

Subsequently, the conversation data acquisition unit 110 performs the speaker classification process on the conversation data on which the section detection process is performed (step S103). In the second example embodiment, the feature quantity acquisition unit 150 obtains the second feature quantity from the conversation data on which the speaker classification process is performed (step S201). As described above, the feature quantity acquisition unit 150 may obtain the second feature quantity from other than the conversation data.

On the other hand, the conversation data acquisition unit 110 performs the speech recognition process on the conversation data on which the section detection process is performed (step S104). Subsequently, the keyword extraction unit 120 extracts the keyword from the conversation data on which the speech recognition process is performed (step S105). At this time, the keyword extraction unit 120 may extract the keyword by using the result of the speaker classification process (e.g., by distinguishing speakers). Subsequently, the feature quantity extraction unit 130 extracts the first feature quantity corresponding to the keyword extracted by the keyword extraction unit 120 (step S106).

The steps S103 and S201 (i.e., processing steps on a left side of the flow) and the steps S104, S105 and S106 (i.e., processing steps on a right side of the flow) may be performed simultaneously in parallel, or may be sequentially performed one after the other.

Subsequently, in the second example embodiment, the availability determination unit 160 compares the first feature quantity extracted by the feature quantity extraction unit 130 with the second feature quantity obtained by the feature quantity acquisition unit 150, and determines whether or not the speaker who says the keyword is identifiable from the first feature quantity (step S202). Here, when it is determined that the speaker who says the keyword is identifiable from the first feature quantity (step S202: YES), the verification information generation unit 140 generates the information for collation/verification by associating the keyword extracted by the keyword extraction unit 120 with the first feature quantity extracted by the feature quantity extraction unit 130 (step S107). On the other hand, when it is determined that the speaker who says the keyword is not identifiable from the first feature quantity (step S202: NO), the step S107 is omitted. That is, the information for collation/verification is not generated for the keyword for which the speaker is determined to be not identifiable.

### Technical Effect

Next, a technical effect obtained by the information processing system 10 according to the second example embodiment will be described.

As described in FIG. 4 and FIG. 5, in the information processing system 10 according to the second example embodiment, it is determined whether or not the voice collation/verification by the keyword is possible, by comparing the first feature quantity with the second feature quantity. In this way, it is possible to prevent that the information for collation/verification is generated for the keyword that is not suitable for the voice collation/verification. Therefore, it is possible to increase the accuracy of the voice collation/verification using the information for collation/verification.

### Third Example Embodiment

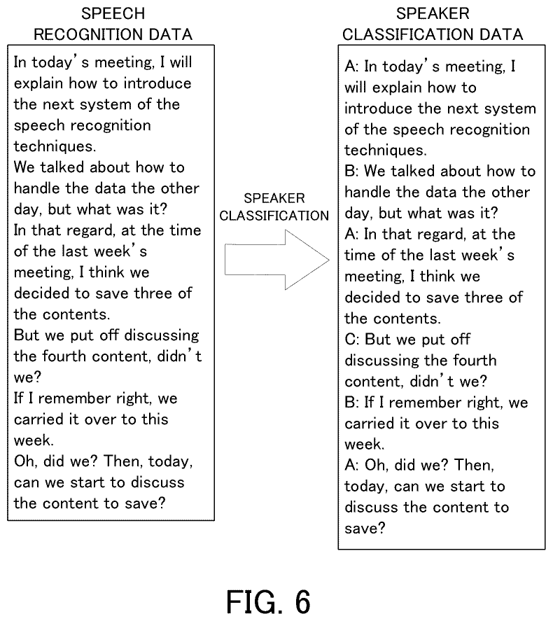

The information processing system 10 according to a third example embodiment will be described with reference to FIG. 6 to FIG. 9. The third example embodiment describes specific examples or the like of the processes performed in the first and second example embodiments, and may be the same as the first and second example embodiments in the configuration and operation. For this reason, a part that is different from each of the example embodiments described above will be described in detail below, and a description of other overlapping parts will be omitted as appropriate.

### (Speaker Classification Process)

First, with reference to FIG. 6, a specific example of the speaker classification process (i.e., the step S103 in FIG. 3 and FIG. 5) performed by the information processing system 10 according to the third example embodiment will be described. FIG. 6 is a conceptual diagram illustrating the specific example of the speaker classification by the information processing system according to the third example embodiment.

Let us assume that speech recognition data (i.e., data obtained by converting the conversation data into text) as illustrated in FIG. 6 is obtained in the information processing system according to the third example embodiment. In this case, in the speaker classification process, a label corresponding to the speaker may be added to each section of the speech recognition data. In the example illustrated in FIG. 6, labels corresponding to a speaker A, a speaker B, and a speaker C are added to respective sections of the speech recognition data. This makes it possible to recognize which speaker speaks in which section.

### (Speaker Integration Process)

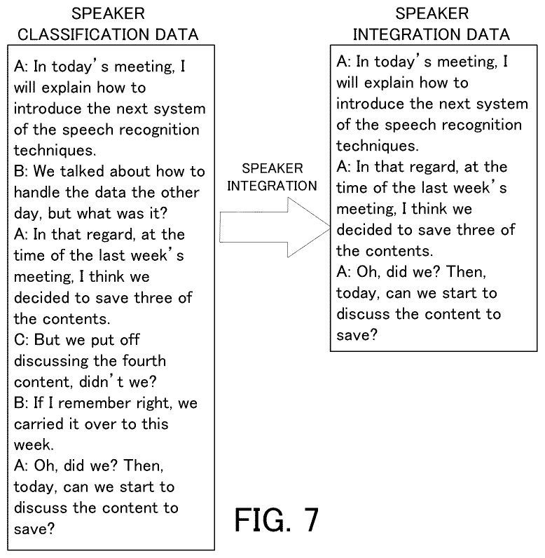

Next, with reference to FIG. 7, a specific example of a speaker integration process (i.e., a process of narrowing down a speaker from speaker classification data) performed by the information processing system 10 according to the third example embodiment will be described. FIG. 7 is a conceptual diagram illustrating the specific example of the speaker integration by the information processing system according to the third example embodiment.

Let us assume that speaker classification data (i.e., data obtained by the speaker classification) as illustrated in FIG. 7 is obtained by the information processing system 10 according to the third example embodiment. In this case, in the speaker integration process, the section in which any one speaker speaks, may be extracted from the speaker classification data. In the example illustrated in FIG. 7, a section in which the speaker A speaks is extracted. In addition to or instead of this, a process of extracting a section in which another speaker speaks may be performed.

### (Keyword Extraction Process)

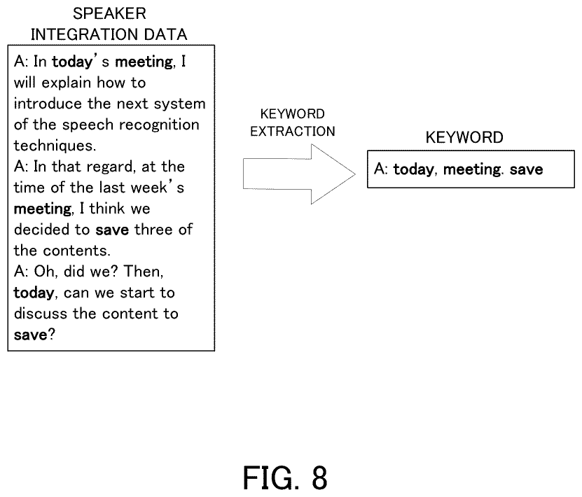

Next, with reference to FIG. 8, a specific example of a keyword extraction process (i.e., a process of extracting the keyword from the speaker integration data) performed by the information processing system 10 according to the third example embodiment will be described. FIG. 8 is a conceptual diagram illustrating the specific example of the keyword extraction by the information processing system according to the third example embodiment.

Let us assume that the speaker integration data as illustrated in FIG. 8 is obtained by the information processing system 10 according to the third example embodiment. In this case, in the keyword extraction process, a word that is said a plurality of times in the speaker integration data are extracted as the keyword. In the example illustrated in FIG. 8, three words of “today”, “meeting”, and “save” in bold are said a plurality of times. Therefore, these three words are extracted as the keywords. When the speaker integration data are obtained for a plurality of speakers (e.g., when the speaker integration data are also obtained for the speaker B and the speaker C), a process of extracting the keyword may be performed for each of the speakers.

### (Keyword Storage)

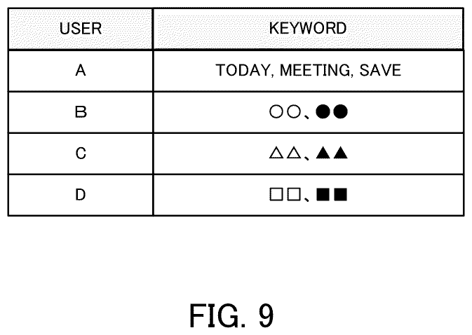

Next, with reference to FIG. 9, a specific example of a storage aspect of the keyword in the information processing system 10 according to the third example embodiment will be described with reference to FIG. 9. FIG. 9 is a table illustrating the example of the storage aspect of the keyword in the information processing system according to the third example embodiment.

As illustrated in FIG. 9, the keyword extracted by the keyword extraction process may be stored separately for each speaker. For example, when there are the speaker A, the speaker B, the speaker C, and a speaker D, the keyword extracted from a speaking section of the speaker A is stored as a keyword corresponding to the speaker A. The keyword extracted from a speaking section of the speaker B is stored as a keyword corresponding to the speaker B. The keyword extracted from a speaking section of the speaker C is stored as a keyword corresponding to the speaker C. The keyword extracted from a speaking section of the speaker D is stored as a keyword corresponding to the speaker D. When the information for collation/verification is generated from these keywords, the information for collation/verification may also be stored for each speaker.

### Technical Effect

Next, a technical effect obtained by the information processing system 10 according to the third example embodiment will be described.

As illustrated in FIG. 6 to FIG. 9, according to the information processing system 10 in the third example embodiment, it is possible to perform various processes of generating the information for collation/verification in an appropriate manner. The various processes, however, are not limited to the above-described example embodiment, and the various processes may be performed in a different aspect from the aspect described here.

### Fourth Example Embodiment

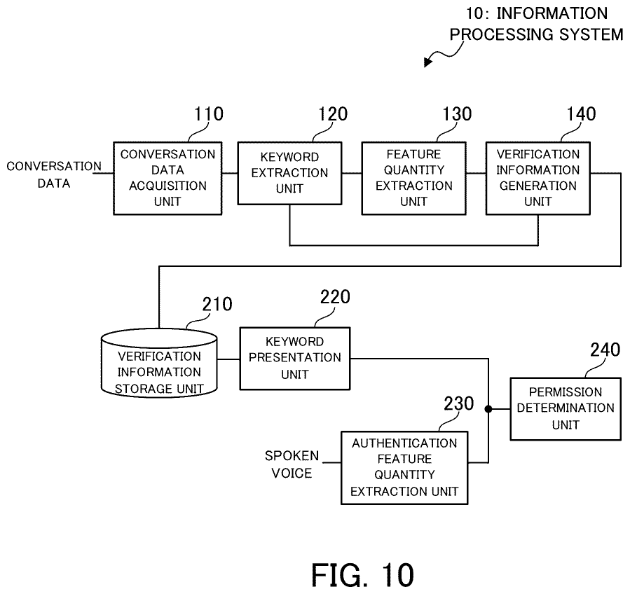

The information processing system 10 according to a fourth example embodiment will be described with reference to FIG. 10 to FIG. 13. The fourth example embodiment is partially different from the first to third example embodiments only in the configuration and operation, and may be the same as the first to third example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the fourth example embodiment will be described with reference to FIG. 10. FIG. 10 is a block diagram illustrating the functional configuration of the information processing system according to the fourth example embodiment. In FIG. 10, the same components as those illustrated in FIG. 2 carry the same reference numerals.

As illustrated in FIG. 10, the information processing system 10 according to the fourth example embodiment includes, as components for realizing the functions thereof, the conversation data acquisition unit 110, the keyword extraction unit 120, the feature quantity extraction unit 130, the verification information generation unit 140, a verification information storage unit 210, a keyword presentation unit 220, an authentication feature quantity extraction unit 230, and a permission determination unit 240. That is, the information processing system 10 according to the fourth example embodiment further includes the verification information storage unit 210, the keyword presentation unit 220, the authentication feature quantity extraction unit 230, and the permission determination unit 240, in addition to the configuration in the first example embodiment (refer to FIG. 2). The verification information storage unit 210 may be realized or implemented by the storage apparatus 14, for example. Each of the keyword presentation unit 220, the authentication feature quantity extraction unit 230, and the permission determination unit 240 may be a processing block that is realized or implemented by the processor 11 (see FIG. 1), for example.

The verification information storage unit 210 is configured to store the information for collation/verification generated by the verification information generation unit 140. The collation information storage unit 210 may be configured to store the information for collation/verification, for each speaker who participates in a conversation, as already described (see FIG. 9). The information for collation/verification stored in the verification information storage unit 210 is readable by the keyword presentation unit 220 as appropriate.

The keyword presentation unit 220 is configured to present the keyword included in the information for collation/verification stored in the verification information storage unit 210, to a user who requests a predetermined process for the conversation data. The keyword presentation unit 220 may present the keyword, for example, by using the output apparatus 16 (see FIG. 1). The keyword presentation unit 220 may present the keyword at a timing when the user performs an operation for performing the predetermined process (e.g., right-clicking, double-clicking, etc.). An example of the predetermined process includes a process of opening a file of the conversation data, a process of decrypting an encrypted file of the conversation data, a process of editing a file of the conversation data, or the like.

When the information for collation/verification is stored for each speaker, the keyword presentation unit 220 may determine which speaker is the user, and may then present the keyword corresponding to that speaker. The keyword presentation unit 220 may determine the speaker, for example, from a user input (e.g., an input of a name or a personal ID, etc.) and may present the keyword corresponding to the speaker. Alternatively, the keyword presentation unit 220 may determine which speaker, by using face authentication or the like, and may present the keyword corresponding to the speaker.

Furthermore, when the verification information storage unit 210 stores a plurality of keywords, the keyword presentation unit 220 may select and present the keyword to be presented, from the stored plurality of keywords. In addition, the keyword presentation unit 220 may jointly present a plurality of keywords. In this case, the keyword presentation unit 220 may jointly present a predetermined number of keywords. Alternatively, the keyword presentation unit 220 may select a keyword such that the length of the joined keyword is sufficient to identify the speaker (i.e., such that appropriate voice collation/verification can be performed). For example, when an utterance/speaking of 1.5 seconds is required to identify the speaker, three words, each corresponding to 0.5 seconds, may be selected and jointly presented.

The authentication feature quantity extraction unit 230 is configured to extract a feature quantity related to a voice (hereinafter referred to as a “third feature quantity”), from the content of what the user speaks after the keyword is presented (i.e., the content of an utterance/speaking corresponding to the presented keyword). The third feature quantity is a feature quantity that may be collated/verified with the first feature quantity (i.e., the feature quantity stored in association with the keyword, as the information for collation/verification).

The permission determination unit 240 compares the first feature quantity associated with the keyword presented by the keyword presentation unit 220, with the third feature quantity extracted by the authentication feature quantity extraction unit 230, and determines whether or not to permit the user to perform the predetermined process. Specifically, the permission determination unit 240 may permit the user to perform the predetermined process, when it is determined that a person who says the keyword in the conversation data and the user who requests the predetermined process for the conversation data are the same person, as a result of the collation/verification of the first feature quantity with the third feature quantity. In addition, when it is determined that the person who says the keyword in the conversation data and the user who requests the predetermined process for the conversation data are not the same person, the user may be prohibited from performing the predetermined process.

### (Permission Determination Operation)

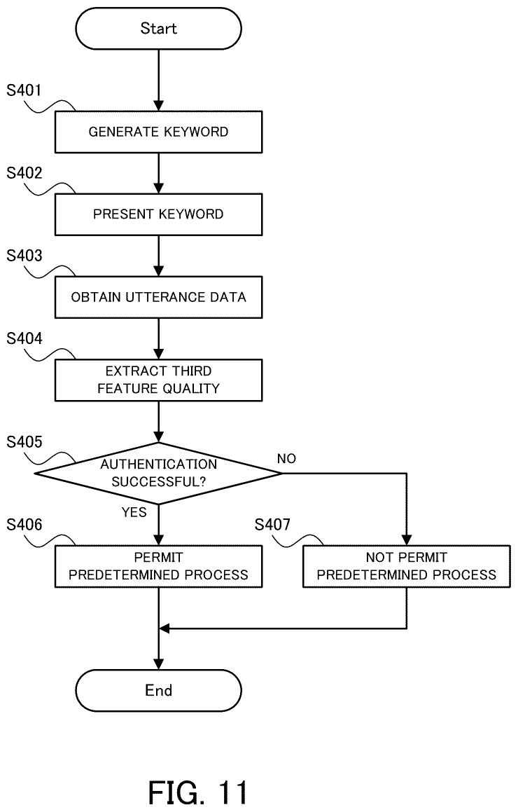

Next, with reference to FIG. 11, a flow of an operation of determining whether or not to permit the predetermined process (hereinafter referred to as a “permission determination operation”) by the information processing system 10 according to the fourth example embodiment will be described. FIG. 11 is a flowchart illustrating a flow of the permission determination operation by the information processing system according to the fourth example embodiment. The permission determination operation illustrated in FIG. 11 is assumed to be performed after the information generation operation described in the first and second example embodiments is performed (in other words, in a situation where the information for collation/verification is generated).

As illustrated in FIG. 11, in the permission determination operation by the information processing system 10 according to the fourth example embodiment, first, the keyword presentation unit 220 reads the information for collation/verification stored by the verification information storage unit 210 and generates the keyword to be presented to the user (step S401). Then, the keyword presentation unit 220 presents the generated keyword to the user (step S402).

When one keyword is presented to the user, the keyword presentation unit 220 may directly present the keyword included in the read information for collation/verification. Furthermore, when a plurality of keywords are presented to the user, the keyword presentation unit 220 may jointly present the keywords included in the read information for collation/verification. A specific example of keyword will be described in detail later.

Subsequently, the authentication feature quantity extraction unit 230 obtains utterance data on the user (specifically, the speech information obtained by the utterance/speaking of the user who receives the presentation of the keyword) (step S403). Then, the authentication feature quantity extraction unit 230 extracts the third feature quantity from the obtained utterance data (step S404).

Subsequently, the permission determination unit 240 performs an authentication process by collating/verifying the first feature quantity corresponding to the presented keyword with the third feature quantity extracted by the authentication feature quantity extraction unit 230 (step S405). Here, when the authentication is successful (step S405: YES), the permission determination unit 240 permits the user to perform the predetermined process (step S406). On the other hand, when the authentication is not successful (step S405: NO), the permission determination unit 240 does not permit the user to perform the predetermined process (step S407).

### (Example of Presentation of Keyword)

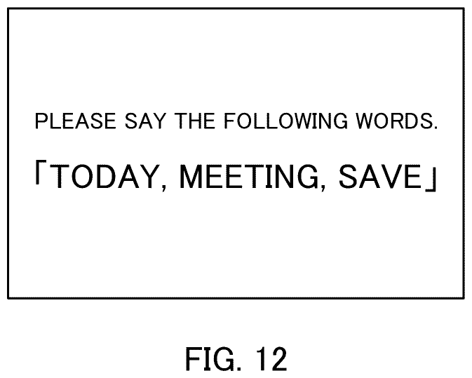

Next, an example of the presentation of the keyword by the keyword presentation unit 220 according to the fourth example embodiment will be described with reference to FIG. 12. FIG. 12 is a plan view illustrating the example of the presentation by the information processing system according to the fourth example embodiment.

As illustrated in FIG. 12, the keyword presentation unit 220 may display the keyword on a display, thereby to present the keyword to the user. In this example, three keywords, “today”, “meeting”, and “save” are presented to the user. In addition to the keywords, a message such as “Please say the following words” may be displayed to encourage the user to say the keyword. The presentation of the keyword may be performed by audio. Specifically, the keywords and the message displayed in FIG. 12 may be audio-outputted by using a speaker or the like.

Although the user is encouraged to say all the three keywords presented here, the user may be encouraged to select and say a part of the plurality of presented keywords. In this case, a message such as “Please select and say one of the following keywords” may be displayed. Furthermore, when the user is encouraged to say a plurality of keywords, order of the keywords may be fixed, or may not be fixed. Specifically, when the three keywords of “today”, “meeting”, and “save” are presented to the user, the authentication may be successful only when the user speaks in the order of “today”, “meeting”, and “save” (i.e., in the displayed order), or the authentication may be successful even when the user speaks in the order of “meeting”, “save”, and “today” (i.e., in the order that is different from the displayed order).

### (Example of Display of File)

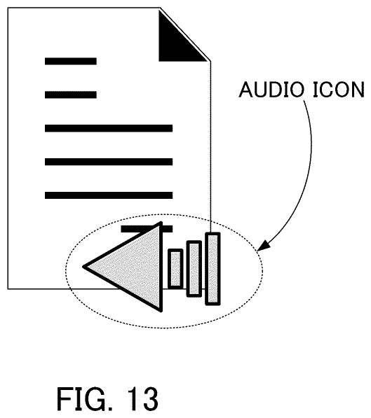

Next, with reference to FIG. 13, an example of the display of a data file (i.e., a file that is a target of the predetermined process) handled by the information processing system 10 according to the fourth example embodiment will be described. FIG. 13 is a plan view illustrating the example of the display of the file handled by the information processing system according to the fourth example embodiment.

As illustrated in FIG. 13, the data file handled by the information processing system 10 according to the fourth example embodiment may be displayed with an audio icon. In this way, the user who requests the predetermined process for the conversation may be able to intuitively understand how to authenticate. That is, it is possible to visually inform the user of the data file that can be authenticated by the utterance/speaking of the keyword.

### Technical Effect

Next, a technical effect obtained by the information processing system 10 according to the fourth example embodiment will be described.

As described in FIG. 10 to FIG. 13, in the information processing system 10 according to the fourth example embodiment, whether or not the predetermined process can be performed on the conversation data, is determined on the basis of the content of what the user speaks when the keyword is presented. In this way, it is possible to properly determine whether or not the user who requests the predetermined process has the authority to perform the predetermined process. In other words, it is possible to properly determine whether or not the user is a person who participates in a conversation. Therefore, it is possible to prevent that the predetermined process is performed by a third party who does not participate in the conversation. As a method of permitting the predetermined process by the utterance/speaking, a method of preparing a predetermined template form in advance may be considered, for example; however, there is a possibility of wiretapping in the utterance/speaking. In addition, the keyword may be changed every time, but it is time-consuming and the keyword may be forgotten. According to the information processing system 10 of this example embodiment, however, the keyword extracted from the conversation data may be presented and the predetermined process may be permitted by the utterance/speaking of the keyword. Therefore, it is possible to solve all the problems described above.

### Fifth Example Embodiment

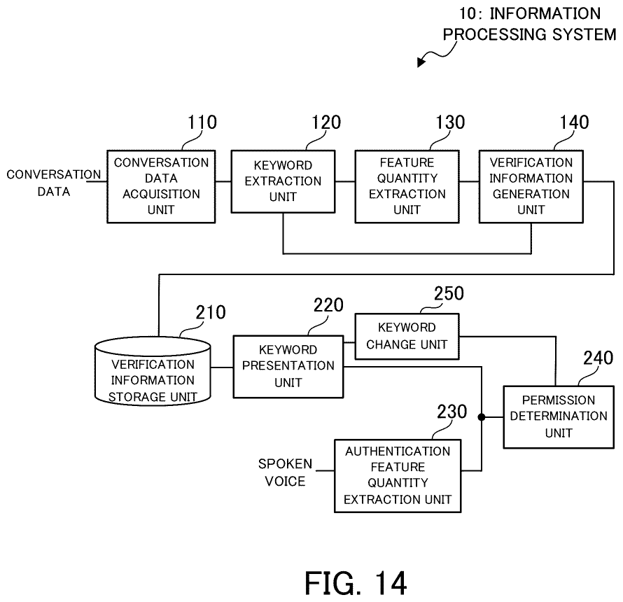

The information processing system 10 according to a fifth example embodiment will be described with reference to FIG. 14 to FIG. 16. The fifth example embodiment is partially different from the fourth example embodiment only in the configuration and operation, and may be the same as the first to fourth example embodiments in the other parts. For this reason, a part that is different from each of the example embodiments described above will be described in detail below, and a description of other overlapping parts will be omitted as appropriate.

### (Functional Configuration)

First, a functional configuration of the information processing system 10 according to the fifth example embodiment will be described with reference to FIG. 14. FIG. 14 is a block diagram illustrating the functional configuration of the information processing system according to the fifth example embodiment. In FIG. 14, the same components as those illustrated in FIG. 10 carry the same reference numerals.

As illustrated in FIG. 14, the information processing system 10 according to the fifth example embodiment includes, as components for realizing the functions thereof, the conversation data acquisition unit 110, the keyword extraction unit 120, the feature quantity extraction unit 130, the verification information generation unit 140, the verification information storage unit 210, the keyword presentation unit 220, a authentication feature quantity extraction unit 230, the permission determination unit 240, and a keyword change unit 250. That is, the information processing system 10 according to the fifth example embodiment further includes the keyword change unit 250, in addition to the configuration in the fourth example embodiment (see FIG. 10). The keyword change unit 250 may be a processing block realized or implemented by the processor 11 (see FIG. 1), for example.

The keyword change unit 250 is configured to change the keyword presented by the keyword presentation unit 220. Specifically, the keyword change unit 250 is configured to change the keyword presented by the keyword presentation unit 220, when the permission determination unit 240 does not permit the user to perform the predetermined process on the conversation data.

### (Permission Determination Operation)

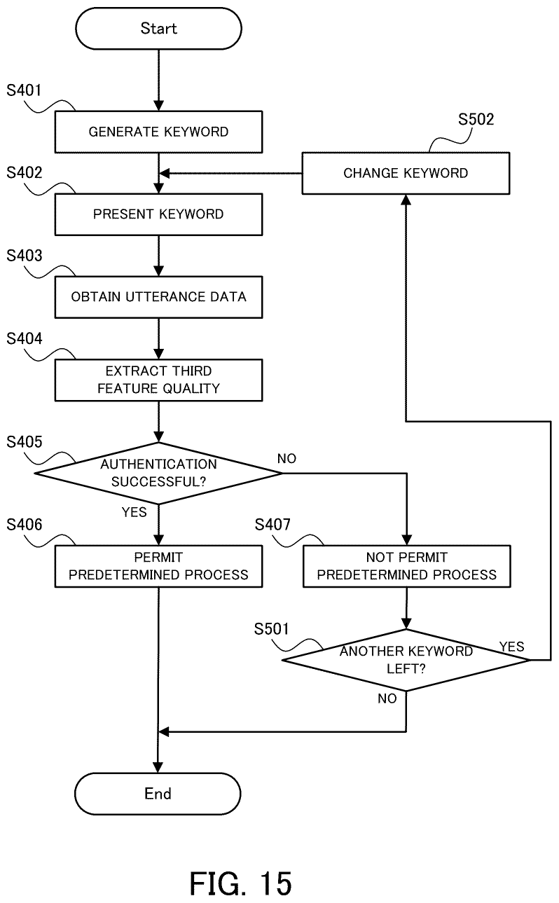

Next, with reference to FIG. 15, a flow of the permission determination operation by the information processing system 10 according to the fifth example embodiment will be described. FIG. 15 is a flowchart illustrating the flow of the permission determination operation by the information processing system according to the fifth example embodiment. In FIG. 15, the same steps as those illustrated in FIG. 11 carry the same reference numerals.

As illustrated in FIG. 15, in the permission determination operation performed by the information processing system 10 according to the fifth example embodiment, first, the keyword presentation unit 220 reads the information for collation/verification stored by the verification information storage unit 210 and generates the keyword to be presented to the user (step S401). Then, the keyword presentation unit 220 presents the generated keyword to the user (step S402).

Subsequently, the authentication feature quantity extraction unit 230 obtains the utterance data on the user (specifically, the speech information obtained by the utterance/speaking of the user) (step S403). Then, the authentication feature quantity extraction unit 230 extracts the third feature quantity from the obtained utterance data (step S404).

Subsequently, the permission determination unit 240 performs the authentication process by collating/verifying the first feature quantity corresponding to the presented keyword with the third feature quantity extracted by the authentication feature quantity extraction unit 230 (step S405). Here, when the authentication is successful (step S405: YES), the permission determination unit 240 permits the user to perform the predetermined process (step S406). On the other hand, when the authentication is not successful (step S405: NO), the permission determination unit 240 does not permit the user to perform the predetermined process (step S407).

Especially in this example embodiment, when the user is not permitted to perform the predetermined process, the keyword change unit 250 determines whether or not there is another keyword left (i.e., another keyword that is not yet presented) (step S501). When there is another keyword left (step S501: YES), the keyword change unit 250 changes the keyword presented by the keyword presentation unit 220 to another keyword (step S502). In such a case, the process is restarted from the step S402. That is, based on the utterance/speaking of the changed keyword, the same determination is performed again. When there is no other keyword left (step S501: NO), a series of the processing steps is ended without permitting the user to perform the predetermined process.

### (Example of Change in Keyword)

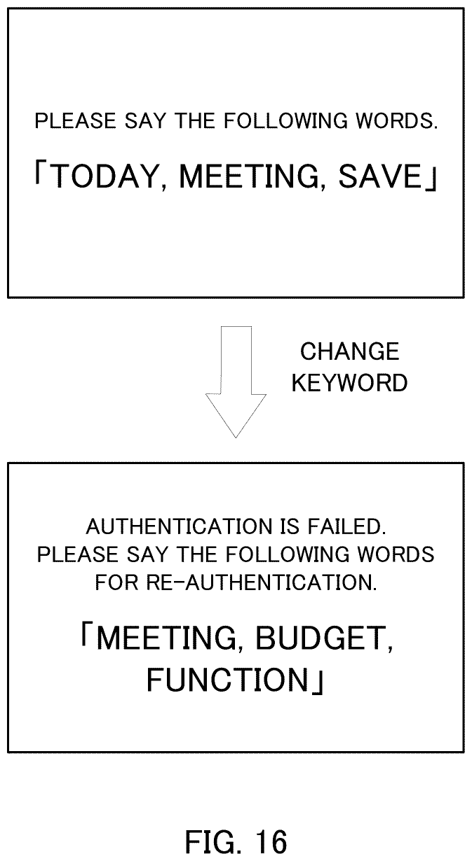

Next, an example of a change in the keyword by the keyword change unit 250 according to the fifth example embodiment will be described with reference to FIG. 16. FIG. 16 is a plan view illustrating an example of a keyword display change by the information processing system according to the fifth example embodiment.

As illustrated in FIG. 16, it is assumed that the three keywords of “today”, “meeting”, and “save” are presented at first. When it is determined that the user is not permitted to perform the predetermined process, the keyword change unit 250 changes the keyword to be presented, to three keywords of “meeting,” “budget,” and “function.” In this way, the keyword change unit 250 may change only a part of the keywords. That is, when a plurality of keywords are jointly presented, the keyword that is partially duplicated may be presented before and after the change. The keyword change unit 250 may change all the keywords. Furthermore, the keyword change unit 250 may change the number of keywords to be displayed.

When changing the keyword, the keyword presentation unit 220 may change the message displayed together with the keyword. For example, as illustrated in FIG. 16, a message of “authentication is failed. Please say the following words for re-authentication” may be displayed. In this way, it is possible to encourage the user to say the keyword again.

### Technical Effect

Next, a technical effect obtained by the information processing system 10 according to the fifth example embodiment will be described.

As described in FIG. 14 to FIG. 16, in the information processing system 10 according to the fifth example embodiment, when the authentication process using the keyword is failed, the keyword presented to the user is changed. In the normal biometric authentication and password collation/verification, it is hardly possible to change the information for collation/verification; however, the plurality of keywords according to the fifth example embodiment can be changed because they indicate identity. In this way, even when false rejection occurs in the authentication process, it is possible to perform the authentication process again. Especially in this example embodiment, the keyword is changed in the re-authentication, and thus, even when the keyword is inappropriate for the collation/verification, an appropriate authentication process is performed after the change.

### Sixth Example Embodiment

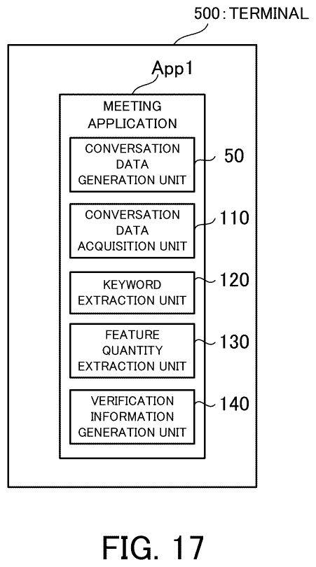

The information processing system 10 according to a sixth example embodiment will be described with reference to FIG. 17 to FIG. 19. The sixth example embodiment describes specific application examples of the information processing system according to the first to fifth example embodiments, and may be the same as the first to fifth example embodiments in the configuration and operation. For this reason, a part that is different from each of the example embodiments described above will be described in detail below, and a description of other overlapping parts will be omitted as appropriate.

### (Applied to Common Application to Meeting Application)

First, with reference to FIG. 17, an example in which the information processing system 10 according to the sixth example embodiment is applied to a common application to a meeting application for generating the conversation data will be described. FIG. 17 is version 1 of a block diagram illustrating an application example of the information processing system according to the sixth example embodiment. In FIG. 17, for convenience of explanation, only the conversation data acquisition unit 110, the keyword extraction unit 120, the feature quantity extraction unit 130, and the verification information generation unit 140 (i.e., the components in the first example embodiment (see FIG. 2)) are illustrated as the components of the information processing system 10 according to the sixth example embodiment, but the information processing system 10 according to the sixth example embodiment may include the components described in the second to fifth example embodiments.

As illustrated in FIG. 17, the information processing system 10 according to the sixth example embodiment may be realized or implemented as a partial function of a meeting application App1 installed in a terminal 500. In this case, the conversation data acquisition unit 110 may be configured to obtain the conversation data generated in a conversation data generation unit 50 owned by the meeting application App1.

(Applied to Different Application from Meeting Application)

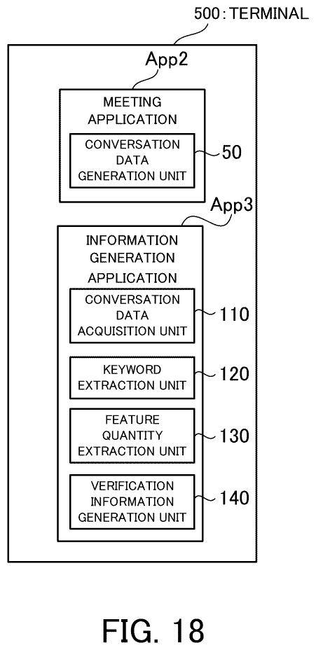

Next, with reference to FIG. 18, an example in which the information processing system according to the sixth example embodiment is applied to a different application from the meeting application for generating the conversation data will be described. FIG. 18 is version 2 of a block diagram illustrating an application example of the information processing system according to the sixth example embodiment. In FIG. 18, the same components as those illustrated in FIG. 17 carry the same reference numerals.

As illustrated in FIG. 18, the information processing system 10 according to the sixth example embodiment may be realized or implemented as a function of an application (an information generation application App3) that is different from a meeting application App2 installed in the terminal 500. In this case, the conversation data generated in the conversation data generation unit 50 is obtained by the conversation data acquisition unit 110 by linking the meeting application App2 with the information generation application App3.

(Applied to Application in Different Terminal from that of Meeting Application)

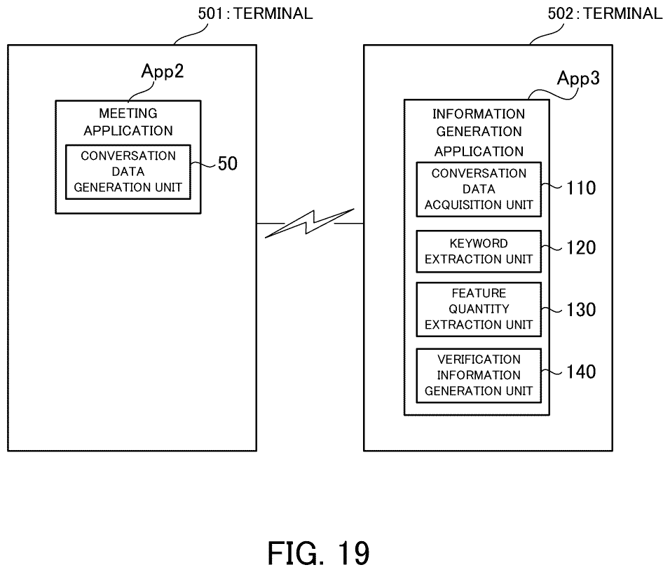

Next, with reference to FIG. 19, an example in which the information processing system 10 according to the sixth example embodiment is applied to an application in a different terminal from that of the meeting application for generating the conversation data will be described. FIG. 19 is version 3 of a block diagram illustrating an application example of the information processing system according to the sixth example embodiment. In FIG. 19, the same components as those illustrated in FIG. 18 carry the same reference numerals.

As illustrated in FIG. 19, the information processing system 10 according to the sixth example embodiment may be realized or implemented as the function of the information generation application App3 installed in a different terminal (i.e., a terminal 502) from a terminal 501 in which the meeting application App2 is installed. In this case, the conversation data generated in the conversation data generation unit 50 is obtained by the conversation data acquisition unit 110 by performing data communication between the terminal 501 in which the meeting application App2 is installed and the terminal 502 in which the information generation application App3 is installed.

Various types of information (e.g., the conversation data, the keyword, the feature quantity, etc.) to be used in the applications App1 to App3 or the like may be stored not in storages of the terminals 500, 501 and 502, but in a storage apparatus of an external server, or the like. In this case, the terminals 500, 501, and 502 may communicate with the external server if necessary, and may transmit and receive the information to be used as appropriate.

### Technical Effect

Next, a technical effect obtained by the information processing system 10 according to the sixth example embodiment will be described.

As described in FIG. 16 to FIG. 19, according to the information processing system 10 in the sixth example embodiment, it is possible to realize various functions in the first to fifth example embodiments in an appropriate manner. The application examples described here are merely an example, and the function of the information processing system 10 according to this example embodiment may be realized in an aspect that is not described here. Furthermore, in the sixth example embodiment, the meeting application (an application for video-recording or sound-recording a meeting/conference) is described as an example of the application for generating the conversation data, but even if the meeting application is replaced with another application, it is similarly applicable.

### Seventh Example Embodiment

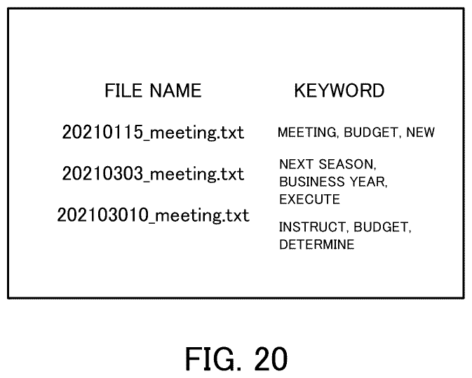

The information processing system 10 according to a seventh example embodiment will be described with reference to FIG. 20. The seventh example embodiment is partially different from the first to sixth example embodiments only in the configuration and operation, and may be the same as the first to sixth example embodiments in the other parts. For this reason, a part that is different from each of the example embodiments described above will be described in detail below, and a description of other overlapping parts will be omitted as appropriate.

### (Display of Management Screen)

First, an example of display (especially, an example of display of a management screen) by the information processing system 10 according to the seventh example embodiment will be described with reference to FIG. 20. FIG. 20 is a plan view illustrating the example of display by the information processing system 10 according to the seventh example embodiment.

As illustrated in FIG. 20, in the information processing system 10 according to the seventh example embodiment, a list of a file name of the conversation data and the keyword generated from the conversation data (i.e., the keyword associated as the information for collation/verification) is displayed on a management screen (e.g., a screen viewed by a system administrator, etc.). The management screen may be displayed by using the output apparatus 16, for example.

In the example in FIG. 20, keywords of “meeting,” “budget,” and “new” are associated with a first file of “20210115_meeting.txt.” Keywords of “next season,” “business year,” and “execute” are associated with a second file of “20210303_meeting.txt.” Keywords of “instruct,” “budget,” and “determine” are associated with a third file of “20210310_meeting.txt.” FIG. 20 illustrates an example of displaying a list of the three files, but a list of more files may be displayed. In addition, when all the files do not fit on the screen, they may be displayed in a scrollable manner, or may be displayed separately on a plurality of pages.

### Technical Effect

Next, a technical effect obtained by the information processing system 10 according to the seventh example embodiment will be described.

As described in FIG. 20, according to the information processing system 10 in the seventh example embodiment, the file name and the keyword are displayed in a list form on the management screen. In this way, it is possible to present, to the system administrator or the like, what type of keyword is associated with which conversation data in an easy-to-understand manner.

A processing method in which a program for allowing the configuration in each of the example embodiments to operate so as to realize the functions in each example embodiment is recorded on a recording medium, and in which the program recorded on the recording medium is read as a code and is executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments. In addition, the program itself may be stored in a server, and a part or all of the program may be downloaded from the server to a user terminal.

### <Supplementary Notes>

The example embodiments described above may be further described as, but not limited to, the following Supplementary Notes below.

### (Supplementary Note 1)

An information processing system according to Supplementary Note 1 is an information processing system including: an acquisition unit that obtains conversation data including speech information on a plurality of people; a keyword extraction unit that extracts a keyword from the speech information; a feature quantity extraction unit that extracts a first feature quantity that is a feature quantity related to a voice when the keyword is said, from the speech information; and a generation unit that generates information for collation/verification, by associating the keyword with the first feature quantity.

### (Supplementary Note 2)

An information processing system according to Supplementary Note 2 is the information processing system according to Supplementary Note 1, further including: a feature quantity acquisition unit that obtains a second feature quantity that is a feature quantity related to a voice of at least one of the plurality of people; and a determination unit that determines whether or not it is possible to identify a speaker who says the keyword from the first feature quantity, by comparing the first feature quantity with the second feature quantity.

### (Supplementary Note 3)

An information processing system according to Supplementary Note 3 is the information processing system according to Supplementary Note 1 or 2, further including: a presentation unit that presents information that encourages a user who requests a predetermined process for the conversation data, to say the keyword for which the information for collation/verification is generated; an authentication feature quantity extraction unit that extracts a third feature quantity that is a feature quantity related to a voice of the user, from content of utterance/speaking of the user; and a permission determination unit that determines whether or not to permit the user to perform the predetermined process, on the basis of a comparison result between the first feature quantity associated with the keyword that the user is encouraged to say and the third feature quantity.

### (Supplementary Note 4)

An information processing system according to Supplementary Note 4 is the information processing system according to Supplementary Note 3, wherein the information for collation/verification is generated for a plurality of keywords, and the presentation unit presents information that encourages the user to say a part of the keywords, and presents information that encourages the user to say another of the keywords when it is determined that the user is not permitted to perform the predetermined process.

### (Supplementary Note 5)

An information processing apparatus according to Supplementary Note 5 is an information processing apparatus including: an acquisition unit that obtains conversation data including speech information on a plurality of people; a keyword extraction unit that extracts a keyword from the speech information; a feature quantity extraction unit that extracts a first feature quantity that is a feature quantity related to a voice when the keyword is said, from the speech information; and a generation unit that generates information for collation/verification, by associating the keyword with the first feature quantity.

### (Supplementary Note 6)

An information processing method according to Supplementary Note 6 is an information processing method executed by at least one computer, the information processing method including: obtaining conversation data including speech information on a plurality of people; extracting a keyword from the speech information; extracting a first feature quantity that is a feature quantity related to a voice when the keyword is said, from the speech information; and generating information for collation/verification, by associating the keyword with the first feature quantity.

### (Supplementary Note 7)

A recording medium according to Supplementary Note 7 is a recording medium on which a computer program that allows at least one computer to execute an information processing method is recorded, the information processing method including: obtaining conversation data including speech information on a plurality of people; extracting a keyword from the speech information; extracting a first feature quantity that is a feature quantity related to a voice when the keyword is said, from the speech information; and generating information for collation/verification, by associating the keyword with the first feature quantity.

### (Supplementary Note 8)

A computer program according to Supplementary Note 8 is a computer program that allows at least one computer to execute an information processing method, the information processing method including: obtaining conversation data including speech information on a plurality of people; extracting a keyword from the speech information; extracting a first feature quantity that is a feature quantity related to a voice when the keyword is said, from the speech information; and generating information for collation/verification, by associating the keyword with the first feature quantity.

This disclosure is not limited to the examples described above and is allowed to be changed, if desired, without departing from the essence or spirit of this disclosure which can be read from the claims and the entire specification. An information processing system, an information processing apparatus, an information processing method and a recording medium with such changes are also intended to be within the technical scope of this disclosure.

### DESCRIPTION OF REFERENCE CODES

10 Information processing system
11 Processor
110 Conversation data acquisition unit
120 Keyword extraction unit
130 Feature quantity extraction unit
140 Verification information generation unit
150 Feature quantity acquisition unit
160 Availability determination unit
210 Verification information storage unit
220 Keyword presentation unit
230 Authentication feature quantity extraction unit
240 Permission determination unit
250 Keyword change unit
500 Terminal

What is claimed is:

1. An information processing system comprising:
at least one memory that is configured to store instructions; and
at least one processor that is configured to execute the instructions to:
obtain conversation data including voice information on a plurality of people;
extract a keyword from the voice information;
extract a first feature quantity that is a feature quantity related to a voice when the keyword is said, from the voice information; and
generates information for collation/verification, by associating the keyword with the first feature quantity.

2. The information processing system according to claim 1, wherein the at least one processor is configured to execute the instructions to:
obtain a second feature quantity that is a feature quantity related to a voice of at least one of the plurality of people; and
determine whether or not it is possible to identify a speaker who says the keyword from the first feature quantity, by comparing the first feature quantity with the second feature quantity.

3. The information processing system according to claim 1, wherein the at least one processor is configured to execute the instructions to:
present information that encourages a user who requests a predetermined process for the conversation data, to say the keyword for which the information for collation/verification is generated;
extract a third feature quantity that is a feature quantity related to a voice of the user, from content of utterance/speaking of the user; and
determine whether or not to permit the user to perform the predetermined process, on the basis of a comparison result between the first feature quantity associated with the keyword that the user is encouraged to say and the third feature quantity.

4. The information processing system according to claim 3, wherein
the information for collation/verification is generated for a plurality of keywords, and
the at least one processor is configured to execute the instructions to present information that encourages the user to say a part of the keywords, and presents information that encourages the user to say another of the keywords when it is determined that the user is not permitted to perform the predetermined process.

5. (canceled)

6. An information processing method executed by at least one computer,
the information processing method comprising:
obtaining conversation data including voice information on a plurality of people;
extracting a keyword from the voice information;
extracting a first feature quantity that is a feature quantity related to a voice when the keyword is said, from the voice information; and
generating information for collation/verification, by associating the keyword with the first feature quantity.

7. A non-transitory recording medium on which a computer program that allows at least one computer to execute an information processing method is recorded,
the information processing method comprising:
obtaining conversation data including voice information on a plurality of people;
extracting a keyword from the voice information;
extracting a first feature quantity that is a feature quantity related to a voice when the keyword is said, from the voice information; and
generating information for collation/verification, by associating the keyword with the first feature quantity.
